(19) United States
(12) Patent Application Publication
(10) Pub. No.: US 2006/0182262 A1
(43) Pub. Date: Aug. 17, 2006

(54) Auxiliary power conservation for telecommunications site

(76) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(21) Appl. No.: 11/057,884

(22) Filed: Feb. 15, 2005

(51) Int. Cl. H04M 3/00

(52) U.S. Cl. 379/323

(57) ABSTRACT

A method and/or system (24) is provided for managing power in a telecommunications site (20) having an auxiliary power supply (22) that selectively powers the site (20) when an outage is experienced in connection with a primary power (30) supply for the site (20). The method includes: detecting a power outage to the primary power supply (30); determining a duration for the detected outage; selecting a power conservation protocol based on the determined duration of the outage; switching to the auxiliary power supply (22); and, implementing the selected power conservation protocol.

### FIELD

The present inventive subject matter relates to the telecommunication arts. Particular application is found in conjunction with the conservation of emergency or back-up power at a remote telecommunications site (e.g., a wireless network base station (BS) or a remote telecommunications switching center (SC)), and the specification makes particular reference thereto. However, it is to be appreciated that aspects of the present inventive subject matter are also amenable to other like applications.

### BACKGROUND

It is generally recognized in the telecommunication arts that a back-up or emergency electrical power supply is desirable at a given telecommunications site or network node. Often, a network site or node (e.g., a BS, SC, etc.) is provided with its own back-up or emergency power supply, i.e., an auxiliary power supply. For example, the auxiliary power supply is particularly advantageous during a period of disruption to a commercial or other primary source that usually provides power to the site. When an outage or interruption to the main or primary power supply is experienced, the site switches to auxiliary power. Previously, the industry has used a variety of means and/or approaches to achieve a suitable auxiliary power supply, including, but not limited to, multiple commercial power feeds, a battery reserve, and/or local power generation equipment, e.g., using a variety of fuels (such as fossil fuels) to run electric generators. The foregoing mechanisms, however, can be expensive to implement, particularly, when the demand for their deployment or use is relatively infrequent. Moreover, certain mechanisms may not be practical in the case of small and/or far remote sites or situations where the location (e.g., a populous metropolitan area) prohibit the noise often associated with running generators.

Commonly, the auxiliary power supply has a limited capacity with respect to the amount and/or duration of power it can supply to its site. All else being equal, the degree to which power consumption can be conserved during back-up/emergency situations, largely determines how much back-up or emergency power capacity a site should be provisioned with. One option is to switch off all but the very essential site functions when a site begins operating on back-up or emergency power. This approach, however, can be unduly drastic, e.g., overly limiting the level and/or quality of services provided by the site. Accordingly, there is a desire to maximize power conservation when operating a site on auxiliary power, while still providing a suitable level and/or quality of service.

Historically, after the primary power has been lost and a site switches operations to auxiliary power, some site functions are turned off or otherwise not supplied power. For example, less important or extraneous non-core functions may be disabled or denied power, e.g., full lighting of the site. In this manner, a desired level and/or quality of service is maintained while limiting power consumption. Accordingly, the finite reserves of power available from the auxiliary supply are conserved thus increasing the operative longevity of the auxiliary power supply, i.e., the duration for which it can supply electrical power. To further extend the longevity of the auxiliary power supply, additional site functions may be shed (i.e., turned off, disabled or otherwise denied power) as the reserve power supply is consumed or depleted. For example, thresholds levels of auxiliary power capacity may be reached where additional portions of service are shed in order to maintain more limited service for a longer duration. However, one drawback is that this selective load shedding is fixed and only occurs after the reserve power supply has already reached a diminished level.

Accordingly, a new and improved power management system and/or method for a telecommunications site is disclosed that overcomes the above-referenced problems and others.

### SUMMARY

In accordance with one embodiment, a method is provided for managing power in a telecommunications site having an auxiliary power supply that selectively powers the site when an outage is experienced in connection with a primary power supply for the site. The method includes: detecting a power outage to the primary power supply; determining a duration for the detected outage; selecting a power conservation protocol based on the determined duration of the outage; switching to the auxiliary power supply; and, implementing the selected power conservation protocol.

In accordance with another aspect, a system is provided that manages power in a telecommunications site having an auxiliary power supply that selectively powers the site when an outage is experienced in connection with a primary power supply for the site. The system includes: means for detecting a power outage to the primary power supply; means for determining a duration for the detected outage; means for selecting a power conservation protocol based on the determined duration of the outage; means for switching to the auxiliary power supply; and, means for implementing the selected power conservation protocol.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating example embodiments and are not to be construed as limiting. Further, it is to be appreciated that the drawings are not to scale.

FIG. 1 is a block diagram illustrating a telecommunications network embodying aspects of the present inventive subject matter.

FIG. 2 is a flow chart showing an exemplary power management process embodying aspect of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components and features that are commonly known in the telecommunications art without further detailed explanation as to their configuration or operation except to the extent they have been modified or altered in accordance with and/or to accommodate the embodiment(s) presented herein.

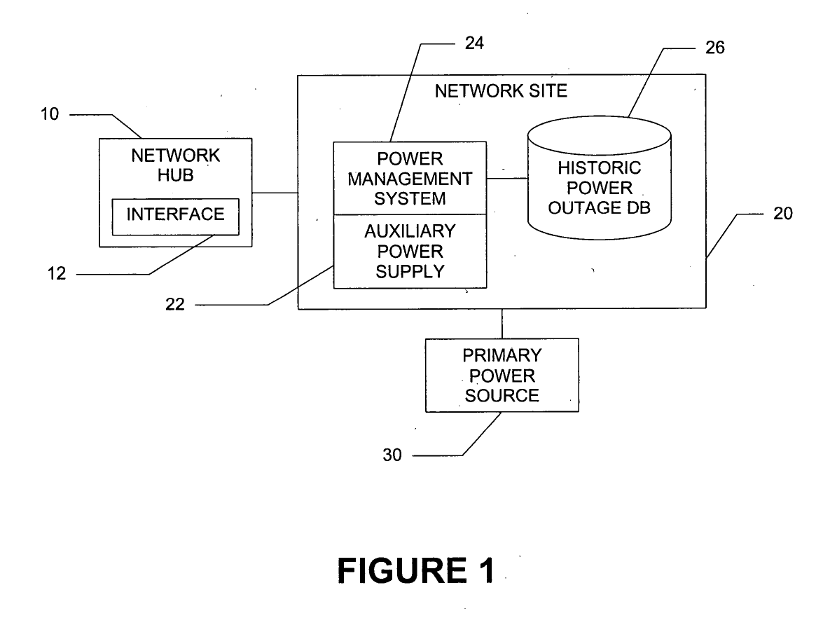

With reference to FIG. 1, a telecommunications network A includes a network hub 10 in operative communication with a remote network site 20. The network A is optionally composed of one or more of the following types of telecommunications networks: a wire or landline network such the Public Switched Telephone Network (PSTN), a wireless network (e.g., including a base station (BS) or plurality thereof, one or more mobile switching centers (MSCs), etc.), a cable network, a data or packet-switched network such as the Internet, etc. Suitably, the hub 10 is a main or primary telecommunications switching center (SC) for the network A, e.g., a central office (CO) including one or more telecommunications switches. For example, the hub 10 may optionally include a class 5 switch such as the Lucent Technologies 5ESS or another like circuit switch and/or a soft-switch and/or suitable packet switching equipment. Alternately, the hub 10 may simply be a switching or network control facility or station from which the network A is monitored and/or controlled, i.e., without any actual traffic switching equipment of its own. Optionally, the hub 10 includes a user interface 12 through which a network administrator or other authorized personnel selectively interacts with the network A. The network site 20 may be any of a number of different network facilities. For example, the site 20 may be a BS, MSC, CO, an end office (EO), etc., equipped in the usual fashion for the particular type of network facility it is.

The site 20 is suitably provisioned with electrical equipment and/or various elements, components and/or the like that operate on electrical power to perform a variety of different functions or tasks carried out by or at the site 20 and/or otherwise provide one or more services supported by or at the site 20. As illustrated, the site 20 is, in the normal course of operation, supplied electrical power for running the aforementioned equipment from a primary power source 30. For example, the primary power source 30 is a commercial power feed from an electric company or the like.

In case power from the primary source 30 is cut-off, interrupted, lost or otherwise fails to be available to the site 20, the site 20 is equipped or otherwise provisioned with an auxiliary power supply 22. Suitably, operating power for the site 20 and/or its equipment is switched to the auxiliary supply 22 upon detection of a power failure from the primary source 30. In the illustrated embodiment, a power management system (PMS) 24 regulates and/or controls power supply and/or consumption for the site 20. Suitably, the PMS 24 is implemented as a software program running on a computer, microprocessor or other central processing unit (CPU). Optionally, the PMS 24 performs a number of monitoring and/or control tasks, including, e.g., detecting power failure from the primary source 30, controlling where power for the site 20 is drawn from (i.e., the primary source 30 or the auxiliary supply 22), monitoring the auxiliary supply 22 to determine the power providing capacity of the auxiliary supply 22, and controlling power consumption by the site 20.

Power consumption by the site 20 is regulated by selectively enabling and/or disabling one or more of the various site functions and/or tasks and/or by selectively limiting or otherwise setting the level and/or quality of telecommunications services provided by the site 20. For example, the PMS 24 may optionally route power to selected equipment, elements or components while denying power to others, or selected features or tasks may be turned-off or turned-on by the PMS 24 as desired to achieve a particular amount of power consumption. Additionally, the PMS 24 may regulate the level or quality of telecommunication services being provided by the site 20 to thereby manage power consumption. Suitably, when deriving power from the primary source 30 during the normal course of operation, the site 20 is operated at or near full power consumption, i.e., with all or nearly all its equipment being fully powered to conduct all the site's designated functions and/or tasks as usual and to provide its normal or nearly normal non-diminished level and/or quality of services.

Suitably, the auxiliary power supply 22 includes a battery reserve, and/or an electric generator run on a local reserve of fuel, such as a fossil fuel. As can be appreciated, typically, the auxiliary power supply 22 has a finite capacity, i.e., it can only supply a certain amount of electrical power to the site 20 before its useful reserves are depleted or exhausted, either completely or nearly completely. It suffices to quantify this power providing capacity as a duration or useful lifespan of the auxiliary supply 22 when the site 20 is operating at a given level of power consumption. For illustrative purposes herein, the term T_{B} shall be used to reference the useful lifespan of the auxiliary supply 22 with the site 20 being operating at a baseline power consumption level, e.g., the aforementioned full power consumption level. It can be appreciated then that as the actual power consumption level of the site 20 is optionally set at different levels via regulation by the PMS 24, the useful lifespan of the auxiliary power supply 22 changes accordingly.

Suitably, when the primary power source 30 experiences an outage and/or the PMS 24 detects that power is not available to the site 20 therefrom, the PMS 24 switches the site 20 over to auxiliary power and implements a power conservation protocol that is responsive to an estimate or indicator of a duration for the outage. In this manner, power management decisions are made based not only on the baseline capacity of auxiliary supply 22, but also based on a likely duration of the outage. Accordingly, by starting to conserve energy at the beginning of the primary power outage as warranted by the likely outage duration, the site 20 is able to optimize its operational state considering the duration it will likely have to run on its limited auxiliary power. That is to say, given an indication or estimate of the outage duration, the power consumption level (or conservation level) of the site 20 can be selected or set by the PMS 24 so that the auxiliary power lifespan meets or exceeds the expected outage duration (within some maximum auxiliary power lifespan) without undue sacrifice to the operational state of the site 20.

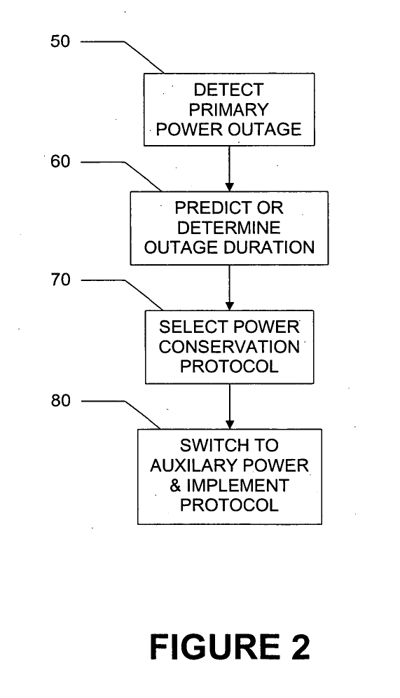

With reference to FIG. 2, a flow chart illustrates an exemplary power management process carried out by the PMS 24. At step 50, the PMS 24 detects a power outage in the primary source 30 or otherwise determines that the power is not available to the site 20 therefrom. At step 60, a duration for the outage is obtained by the PMS 24, e.g., from an appropriate calculation, estimation, indication or otherwise. At step 70, the PMS 24 sets or selects a determined power conservation protocol based upon the obtained outage duration from step 60, and at step 80, the PMS 24 switches the site 20 over to the auxiliary power supply 22 implementing the selected power conservation protocol from step 70.

In a suitable embodiment, the outage duration for a particular primary power outage is determined by the PMS 24 from previous experience, i.e., from prior historical power outage information and/or data, e.g., maintained in a database (DB) 26 accessible by the PMS 24 (see FIG. 1). Suitably, the DB 26 maintains information and/or data regarding one or more prior outages for the site 20 itself and/or optionally any other similarly situated sites. The data maintained optionally includes, without limitation, the durations, dates and/or times of prior outages, causes of prior outages, time spans between successive outages, etc. In one example, as a default, a current power outage duration may simply be estimated as being equal to or approximately equal to the most recent prior outage duration or some weighted or other average of a number of prior outage durations.

Additionally, information about a current outage is optionally obtained by the PMS 24 from the hub 10. For example, a network administrator may use the interface 12 to provide outage data and/or information which is sent in a network control message from the hub 10 to the site 20. Optionally, the control message is an override explicitly indicating the expected outage duration for the site 20. Another piece of data or information that is optionally supplied and/or obtained by the site 20 or PMS 22 is the current Homeland Security code, terrorist threat indicator or the like for the geographic area in which the site 20 is located. This threat indicator is then optionally used as a factor in predicting the duration of an outage and/or for selecting an appropriate power conservation protocol. Optionally, if an outage occurs and no control message is available from the network A regarding a predicted duration for the outage, the security code is used in the duration estimation and/or protocol selection process. For example, in a code “red” security situation (i.e., indicating a high or elevated terrorist threat), optionally, the most restrictive power conservation protocol is selected on the basis that the expected duration of the outage is likely to be relatively long compared to the baseline capacity of the auxiliary supply 22.

Moreover, in addition to the expected duration of the primary power outage, the information obtained by the PMS 24 relating to the nature of the outage and/or the event(s) causing the outage is optionally used to determine which functions, tasks and/or services are to be given priority for power consumption purposes. For example, if the power outage event has associated with it an increased risk to public safety, first responder communications and/or related services may be given priority or dedicated use of the available power reserves.

Suitably, the PMS 24 also includes a “leaming” mode or function. In this mode, the PMS 24 compares actual outage durations to the corresponding predicted or estimated outage durations. Feedback from the comparison is then used to adapt and/or alter future calculations and/or determinations of the duration estimate/prediction.

As illustrated, only one site 20 has been shown in FIG. 1 for clarity and simplification. However, it is to be appreciated the network A suitably includes a plurality of similarly situated sites. Each site has a set of load shedding algorithms or power conservation protocols, e.g., that are pre-established or installed and waiting for a signal to be invoked. The exact nature of the algorithms or protocols suitably differs from site to site based on the nature of services provided at the particular sites, and the available reserve power supply at each site. Following are three illustrative examples of the kinds of power conserving measures that may be taken by a wireless remote site 20 and two examples for a wire or landline site 20:
a remote cell site or BS supporting a number of voice radio channels (e.g., 30), could shut down a portion (e.g., 25) of its transceivers and only originate and complete traffic marked as Wireless Priority Service (WPS) for government authorized emergency response users (e.g., this algorithm or protocol might be appropriate in a Homeland Security code “red” situation);
a remote cell site or BS could limit traffic to 9-1-1 and WPS calls;
a remote cell site could reduce its maximum power settings, thus reducing the effective size or coverage area of the cell site;
in a condition where the outage is expected to be of long duration (e.g., in a code “red” security situation), an EO or CO could conserve power by going into what is commonly known as Essential Line Service (ELS), note, this is an existing feature (originally designed to handle overload conditions) where the office only scans the lines on the ELS for new attempts (while designed to reduce load during an overload condition, this could be applied as a power conservation mechanism in a severe situation); and,
in a less adverse algorithm or protocol an office could stop applying ring voltage after a limited number of rings (e.g., 8 or less) rather than applying it until the office timeout for unanswered calls (typically, around 5 minutes).

Again, a network administrator may know shortly after the start of a primary power outage what was the cause and the expected duration. The administration center could then send new network management commands to the main sites and from there to the remote sites which algorithms or protocols to invoke. Please note that the site is not exposed to any additional risk of an attack since existing network management signaling methodology can be used. Suitably, the new message is just added to the existing procedures. Of course, there is the possibility that such network management communication have also been disrupted by the outage. In that case each site after first trying to query for instructions without response could invoke the algorithm or protocol last invoked on the premise or via some on-site determination process executed by the PMS 24. Commonly, the prior outage is a better than average guess as to the cause of the current outage. This is especially true in the case of a series of short, repeated outages.

Again, each site 20 may optionally have a different configuration, different power demands, and different degrees of auxiliary power capacity. Accordingly, a wide variety of power conservation protocols can be implemented as desired for a particular site and/or application. Nevertheless, for the purpose of illustration, we shall consider, for implementation in wireless cell site or BS, a particularly advantageous case having five levels of severity. Recall, that for purposes of determining an algorithm or power conservation protocol, each site can be viewed as having a reserve power supply capable of providing power for a period of time represented by T_{B} (i.e., the estimated time the auxiliary supply can provide power before exhausting). Please note, that this value has been determined without taking into account the power savings created by the proactive actions taken at the respective power conservation levels, and thus the actual time to exhaust the auxiliary power supply 22 for the site 20 operating at a corresponding power consumption level may in fact be greater than T_{B} when the various power conservation measures are implemented. For example, this explains why some of the following levels are based on percentages greater than 100%. The aforementioned five levels are detailed as follows and they correspond in order to progressively more severe outage conditions.

Suitably, level 1 is such that the outage time is expected to be less than approximately 25% of T_{B}. Please note, that for a given outage different sites may invoke different levels for the same outage because some sites have a smaller T_{B}, while others have a larger T_{B}. For example, this level would apply to a single outage or a series of related outages accruing rapidly. The algorithm or protocol for level 1 would be no reduction of the capability on the backup circuits. This automatically takes into account those power sinks (overhead lighting, heat, etc.) that are not on the backup feed.

Level 2 is suitably invoked when the outage is expected to be less than 50% of T_{B}. For example, a remote cell site could reduce the maximum power settings by one increment, thus reducing the size or coverage area of the cell site.

Suitably, level 3 is such that the outage is expected to be less than about 75% of T_{B}. For example, a remote cell site could reduce the maximum power settings by one increment, thus reducing the size of the cell site and shut down approximately half of its transceivers.

At level 4, suitably, the outage is expected to be less than approximately 150% of T_{B}. For example, a remote cell site with N voice radio channels could shut down around three-quarters of its transceivers and only originate and complete 9-1-1 traffic and traffic marked as WPS for government authorized emergency response users.

Suitably, level 5 is such that the outage is expected to be more than approximately 200% of T_{B} and extreme measures are warranted to extend service for emergency responders as long as possible by restricting all non-emergency traffic. For example, a remote cell site with N voice radio channels could shut down around 90% of its transceivers and only originate and complete traffic marked as WPS for government authorized emergency response users.

As previously described, when an outage occurs to the primary source 30, the site 20 automatically switches to the auxiliary power supply 22. Suitably, the site 20 uses the last known level as the starting point for deciding which behavior to invoke. Alternatively, some range of prior history is used (e.g., by accessing the DB 26). Once a level is decided upon, the service restrictions specified above for the various levels are invoked.

In an interactive mode, a management message is sent to a host site or the hub 10 indicating the time of the start of the outage and the level initially invoked. A new value for T_{B} is created by multiplying the baseline T_{B} by a power savings value associated with the invoked level for the site 20. The site 20 then decrements T_{B} minute by minute as time passes until power is restored. Ideally, as soon as the network operations center or hub 10 has determined the nature of the outage, it will send a maintenance message back to the site 20 with the expected duration of the outage (or optionally an explicit level to be invoked). Suitably, the site 20 reacts by implementing the appropriate level (e.g., a new level) as the case may be in response to the expected duration or explicit level indicated in the received message. The value of T_{B} is then divided by the power saving value of the old level and the new value replaces T_{B}. When the site 20 receives such a message from the hub 10, it will determine the appropriate level and invoke those controls. This T_{B} is then multiplied by the power saving value of the new level and continues to be decremented during the outage. Optionally, the same process is repeated if new management messages are received during the outage. Once the primary power outage has ceased and the auxiliary power supply 22 has been restored, the original baseline site value for T_{B} will again be used.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for managing power in a telecommunications site having an auxiliary power supply that selectively powers the site when an outage is experienced in connection with a primary power supply for the site, the method comprising:
(a) detecting a power outage to the primary power supply;
(b) determining a duration for the detected outage;
(c) selecting a power conservation protocol based on the determined duration of the outage;
(d) switching to the auxiliary power supply; and,
(e) implementing the selected power conservation protocol.

2. The method of claim 1, wherein step (b) comprises:
estimating the duration from data relating to one or more prior power outages to the primary power supply.

3. The method of claim 2, wherein the method further comprises:
maintaining the data from which the duration is estimated in a database accessible by the telecommunications site.

4. The method of claim 1, wherein step (b) comprises:
receiving a message over a telecommunication networks to which the site belongs, said message indicating said duration.

5. The method of claim 1, wherein the auxiliary power supply has a finite baseline lifespan with reference to the site operating at a full power consumption level, and the power conservation protocol selected reduces the power consumption level of the site relative to the full power consumption level thereby extending a useful lifespan of the auxiliary power supply relative to the baseline lifespan.

6. The method of claim 1, wherein the power conservation protocol is selected from a plurality of power conservation protocols, said plurality of protocols being defined to operate the site at a plurality of different power consumption levels.

7. The method of claim 1, wherein the selected power conservation protocol is implemented at or near the beginning of the site switching to auxiliary power.

8. The method of claim 1, wherein the power conservation protocol conserves power by disabling selected power consuming features of the site.

9. A system that manages power in a telecommunications site having an auxiliary power supply that selectively powers the site when an outage is experienced in connection with a primary power supply for the site, the system comprising:
means for detecting a power outage to the primary power supply;
means for determining a duration for the detected outage;
means for selecting a power conservation protocol based on the determined duration of the outage;
means for switching to the auxiliary power supply; and,
means for implementing the selected power conservation protocol.

10. The system of claim 9, wherein the means for determining comprises:
means for estimating the duration from data relating to one or more prior power outages to the primary power supply.

11. The system of claim 10, wherein the system further comprises:
a database accessible by the telecommunications site, said database containing the data from which the duration is estimated.

12. The system of claim 10, wherein the site is a base station for a wireless telecommunications network.

13. The system of claim 12, wherein the power conservation protocol calls for disabling a number of transceivers for the base station.

14. The system of claim 12, wherein the power conservation protocol calls for reducing a maximum power setting for the base station.

15. The system of claim 12, wherein the power conservation protocol calls for limiting traffic carried by the base station to selected types of calls.

16. The system of claim 10, wherein the site is a landline switching center for a telecommunications network.

17. The system of claim 16, wherein the power conservation protocol calls for limiting traffic carried by the switching center to selected types of calls.

18. The system of claim 16, wherein the power conservation protocol calls for limiting an application of ring voltage to a set number of rings.
